(19) United States
(12) Patent Application Publication
(10) Pub. No.: US 2006/0093769 A1
(43) Pub. Date: May 4, 2006

(54) Multilayer tube assembly and methods for forming and using the same

(76) Inventor: Ghislain Biebuyck, Roisin (BE)

Correspondence Address: David D. Beatty;Myers Bigel Sibley & Sajovec, P.A., P. O. Box 37428, Raleigh, NC, 27627, US

(21) Appl. No.: 10/977,704

(22) Filed: Oct. 29, 2004

(51) Int. Cl. B32B 1/08

(52) U.S. Cl. 428/36.91

(57) ABSTRACT

A multilayer tube assembly for use with a fluid includes an inner tube, an outer layer, and an adhesive layer. The inner tube has inner and outer opposed surfaces. The inner surface of the inner tube defines an open, longitudinally extending tube passage to allow flow of the fluid therethrough. The inner tube is formed of metal. The outer layer has an inner surface and surrounds at least a portion of the inner tube. The outer layer is formed of a polymeric material. The adhesive layer is interposed between the outer surface of the inner tube and the inner surface of the outer layer. The adhesive layer secures the outer layer to the inner tube.

### FIELD OF THE INVENTION

The present invention relates to tubes and pipes and, more particularly, to multilayer tube assemblies and methods for forming and using the same.

### BACKGROUND OF THE INVENTION

Flexible multilayer tubes or hoses are commonly employed in fluid distribution systems and heating systems. For example, multilayer hoses are used to distribute water for sanitary applications (e.g., drinking water) and gas. Radiant or heat exchange heating (and/or cooling) systems often include multilayer hoses through which heated (and/or cooled) water is circulated, the multilayer hose being installed in a floor, wall, ceiling, etc.

Commonly, the multilayer tubes as discussed above include three or more tubular layers. A barrier layer is sandwiched between a plastic inner layer and a plastic outer layer. The barrier layer may serve as an oxygen barrier to reduce or prevent oxygen from permeating through the plastic layers and oxygenating the circulating fluid. Excess oxygen in the fluid may tend to accelerate corrosion of ferrous materials in the system. Aluminum is commonly used to form the intermediate barrier layer.

### SUMMARY OF THE INVENTION

According to embodiments of the present invention, a multilayer tube assembly for use with a fluid includes an inner tube, an outer layer, and an adhesive layer. The inner tube has inner and outer opposed surfaces. The inner surface of the inner tube defines an open, longitudinally extending tube passage to allow flow of the fluid therethrough. The inner tube is formed of metal. The outer layer has an inner surface and surrounds at least a portion of the inner tube. The outer layer is formed of a polymeric material. The adhesive layer is interposed between the outer surface of the inner tube and the inner surface of the outer layer. The adhesive layer secures the outer layer to the inner tube. According to some embodiments, the inner tube includes a first metallic layer including the inner surface of the inner tube and a second metallic layer surrounding the first layer and including the outer surface of the inner tube.

According to further embodiments of the present invention, a system includes a supply of a fluid, a tube network, and a fluid transport apparatus. The tube network includes at least one multilayer tube assembly. Each multilayer tube assembly includes an inner tube, an outer layer, and an adhesive layer. The inner tube has inner and outer opposed surfaces. The inner surface of the inner tube defines an open, longitudinally extending tube passage to allow flow of the fluid therethrough. The inner tube is formed of metal. The outer layer has an inner surface and surrounds at least a portion of the inner tube. The outer layer is formed of a polymeric material. The adhesive layer is interposed between the outer surface of the inner tube and the inner surface of the outer layer. The adhesive layer secures the outer layer to the inner tube. According to some embodiments, the inner tube includes a first metallic layer including the inner surface of the inner tube and a second metallic layer surrounding the first layer and including the outer surface of the inner tube.

According to method embodiments of the present invention, a method for forming a multilayer tube assembly includes forming an inner tube having inner and outer opposed surfaces, the inner surface of the inner tube defining an open, longitudinally extending tube passage to allow flow of the fluid therethrough, wherein the inner tube is formed of metal; applying an adhesive layer to the outer surface of the inner tube; forming an outer layer having an inner surface and surrounding at least a portion of the inner tube such that the adhesive layer is interposed between the outer surface of the inner tube and the inner surface of the outer layer, wherein the inner tube is formed of a polymeric material; and adhering the outer layer to the inner tube using the adhesive layer.

According to further method embodiments of the present invention, a method for providing plumbing in an architectural structure for a flow of a fluid includes installing a tube network in the structure. The tube network includes at least one multilayer tube assembly. Each multilayer tube assembly includes an inner tube, an outer layer, and an adhesive layer. The inner tube has inner and outer opposed surfaces. The inner surface of the inner tube defines an open, longitudinally extending tube passage to allow flow of the fluid therethrough. The inner tube is formed of metal. The outer layer has an inner surface and surrounds at least a portion of the inner tube. The outer-layer is formed of a polymeric material. The adhesive layer is interposed between the outer surface of the inner tube and the inner surface of the outer layer. The adhesive layer secures the outer layer to the inner tube.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

FIG. 1 is a partially cut away perspective view of a multilayer tube assembly according to embodiments of the present invention;

FIG. 2 is a cross-sectional view of the tube assembly of FIG. 1 taken along the line 2-2 of FIG. 1;

FIG. 3 is a partially cut away perspective view of a multilayer tube assembly according to further embodiments of the present invention;

FIG. 4 is a cross-sectional view of the tube assembly of FIG. 3 taken along the line 4-4 of FIG. 3;

FIG. 5 is a flow chart illustrating method embodiments according to the present invention for forming tube assemblies;

FIG. 6 is a schematic diagram of an apparatus for forming tube assemblies in accordance with embodiments of the present invention; and

FIG. 7 is a schematic diagram of a building structure and systems therein including tube assemblies as shown in FIGS. 1 and 3.

### DETAILED DESCRIPTION OF EMBODIMENTS OF THE INVENTION

In the drawings, the thickness of lines, layers and regions may be exaggerated for clarity. It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present.

As used herein, the term “and/or” includes any and all combinations of one or more of the associated listed items.

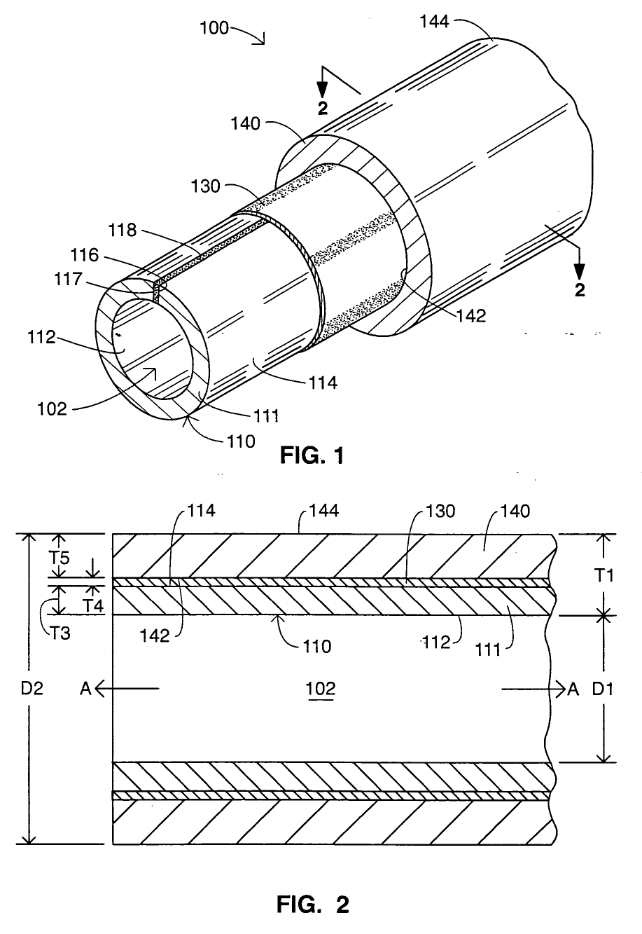

With reference to FIGS. 1 and 2, a multilayer tube assembly 100 according to embodiments of the present invention is shown therein. Generally, the tube assembly 100 has a longitudinal axis A-A (FIG. 2). The multilayer tube assembly 100 includes an inner tube 110, a surrounding outer layer 140, and an intermediate layer of adhesive 130. According to some embodiments, each of the inner tube 110, the adhesive 130, and the outer layer 140 are cylindrical and concentrically arranged about the axis A-A. The inner tube 110 has an inner surface 112 that defines a longitudinally extending tube passage 102. As discussed below, the inner tube 110 is formed of a metallic material while the outer layer 140 is formed of a polymeric material. The inner tube 110, the adhesive 130, and the outer layer 140 are combined so as to form an integral structure. According to some embodiments, the overall tube assembly 100 is flexible.

According to some embodiments, the tube passage 112 has a nominal inner diameter D1 (FIG. 2) of between about 0.2 and 2.755 inches. The overall tube assembly 100 has a nominal outer diameter D2 (FIG. 2) of between about 0.275 and 2.952 inches. According to some embodiments, the nominal overall wall thickness T1 (FIG. 2) of the tube assembly 100 is between about 0.039 and 0.197 inch. The tube assembly 100 may be formed of any discrete length or of indeterminate length.

The inner tube 110 is formed of a single layer 111. The inner surface 112 and the outer surface 114 of the layer 111 serve as the inner and outer surfaces of the inner tube 110. The layer 111 may be formed from a thin, flat, metallic strip that is bent into an elongate cylinder or tubular shape as shown in FIG. 1 such that the opposing lateral edges 116, 117 of the strip are positioned adjacent one another and joined by a longitudinally extending seam 118. The seam 118 may be formed by welding and/or another suitable joining technique, as discussed below. According to some embodiments and as illustrated, the seam 118 is preferably a butt welded seam. According to other embodiments, the seam can be overlap welded.

According to some embodiments, the layer 111 is formed of copper. According to some embodiments, the nominal thickness T3 (FIG. 2) of the layer 111 is between about 0.008 and 0.0236 inch. According to more particular embodiments, the thickness T3 is between about 0.008 and 0.0157 inch.

The welded inner tube 110 forms a mechanically continuous tube. According to some embodiments, the inner tube 110 is preferably impervious to the intended fluid at all intended temperatures and pressures. Accordingly, the fluid will flow through the inner tube 110 without contacting the adhesive 130 or the outer layer 140.

The adhesive 130 is interposed between the outer surface 114 of the inner tube 110 and an inner surface 142 of the outer layer 140 and secures the outer layer 140 to the inner tube 110. According to some embodiments, the adhesive layer 130 is selected from the group consisting of ethylene acrylic acid (EAA), ethylene methyl acrylate (EMA), and mixtures and formulations thereof. According to some embodiments, the adhesive layer 130 is EAA, for example, as described in U.S. Pat. No. 4,484,023 to Gindrup and U.S. Pat. No. 3,309,455 to Mildner. Other copolymers that provide the desired adhesive properties may also be used. According to some embodiments, the layer of adhesive 130 has a nominal thickness T4 (FIG. 2) of between about 0.002 and 0.006 inch.

According to some embodiments, the outer layer 140 is formed of a polyethylene. According to some embodiments, the layer 140 includes at least one of cross-linked polyethylene (PEX), polyethylene of raised temperature resistance (PE-RT), high density polyethylene (HDPE) and a low smoke zero halogen (halogen free) (LSZH) compound. A material of the outer layer 140 may include additives which can enhance physical properties or facilitate manufacturing.

According to some embodiments, the outer layer 140 has a nominal thickness T5 (FIG. 2) of between about 0.031 and 0.078 inch. According to more particular embodiments, the thickness T5 is between about 0.039 and 0.059 inch.

The tube assembly 100 may be particularly suitable for use as heating tubing or sanitary tubing. The copper inner tube 110 serves as an oxygen barrier to prevent or inhibit oxygenation of fluid flowing through the tubing.

The inner tube 110 provides enhanced mechanical strength as compared to tubing including only a polyethylene layer, for example. The inner tube 110 also tends to retain its shape when bent. In this way, the inner tube 110 aids in handling and insulation by resisting “spring back” that the resilient polyethylene outer layer 140 may tend to induce. The adhesive layer 130 may increase the bending properties of the tube assembly 100.

Of particular significance in sanitary tube applications, the inner surface 112 in contact with the flowing fluid is formed of copper, rather than plastic as in certain conventional multilayer or composite tubes. As a result, the risks and concerns regarding Legionella disease (Legionnaires' disease) commonly associated with plastic pipes are obviated.

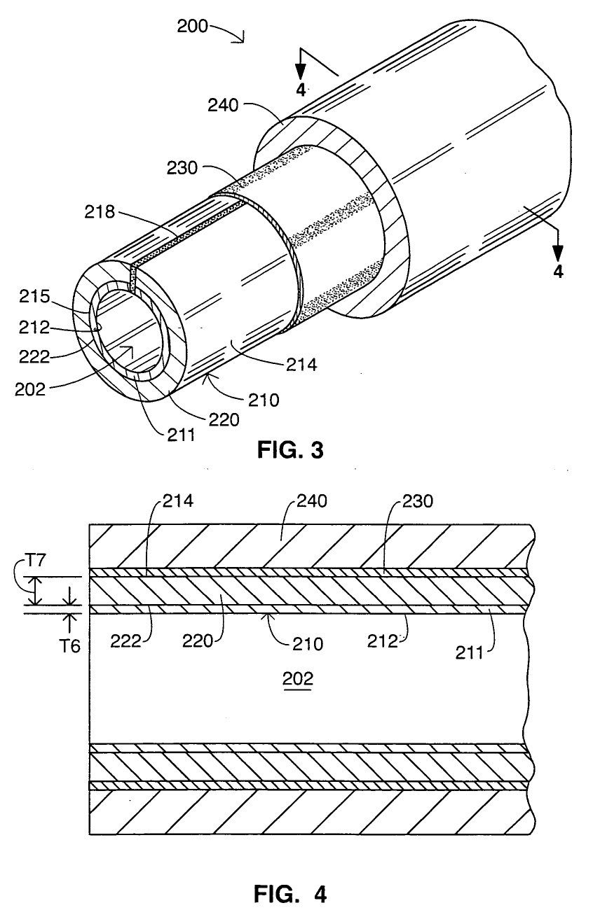

With reference to FIGS. 3 and 4, a multilayer tube assembly 200 according to further embodiments of the present invention is shown therein. The multilayer tube assembly 200 includes a layer of adhesive 230 and an outer layer 240 corresponding to the layer of adhesive 130 and the outer layer 140, respectively. The tube assembly 200 differs from the tube assembly 100 in that the inner tube 210 of the tube assembly 200 is of a bimetallic construction. More particularly, the inner tube 210 includes a first inner layer 211 and a second outer layer 220. The inner surface 212 of the inner layer 211 serves as the innermost surface of the tube assembly 200 and defines the tube passage 202. The outer surface 214 of the outer layer 220 is bonded to the inner surface of the outer layer 240 by the adhesive layer 230.

The layers 211 and 220 are separately formed but bonded to one another at their respective interfacing surfaces 215 and 222 to form an integral, unitary, metal structure. The surfaces 215 and 222 may be metallurgically bonded to one another.

The lateral edges of the layers 211, 220 are welded or otherwise joined to form a seam 218 corresponding to the seam 118. The inner tube 210 forms a mechanically continuous tube as described above with regard to the inner tube 110.

According to some embodiments, the layers 211 and 220 are formed of different metals. According to certain preferred embodiments, the layer 211 is formed of copper (pure copper or copper alloy) and the layer 220 is formed of aluminum. According to some embodiments, the layer 211 is formed of copper and has a nominal thickness T6 (FIG. 4) of between about 0.002 and 0.006 inch. According to certain embodiments, the layer 220 is formed of aluminum (pure aluminum or aluminum alloy) and has a nominal thickness T7 (FIG. 4) of between about 0.006 and 0.039 inch. According to some embodiments, the inner layer 211 is formed of copper and forms between about 15 and 33% of the thickness of the inner tube 210 and the outer layer 220 is formed of aluminum and forms substantially the remainder of the thickness of the inner tube 210.

The multilayer tube assembly 200 may provide the advantages discussed above with respect to the tube assembly 100. Additionally, the additional aluminum layer 220 may serve to provide enhanced shape retention when the tube assembly 200 is bent. Also, the tube assembly 200 may be lighter than a comparable tube assembly 100 with similar performance characteristics.

With reference to FIGS. 1, 5 and 6, multilayer tubes may be formed using methods and apparatus as follows in accordance with embodiments of the present invention. For the purposes of illustration, the methods will be described with reference to the tube assemblies 100, 200. However, tube assemblies of other constructions can be formed using the methods of the present invention.

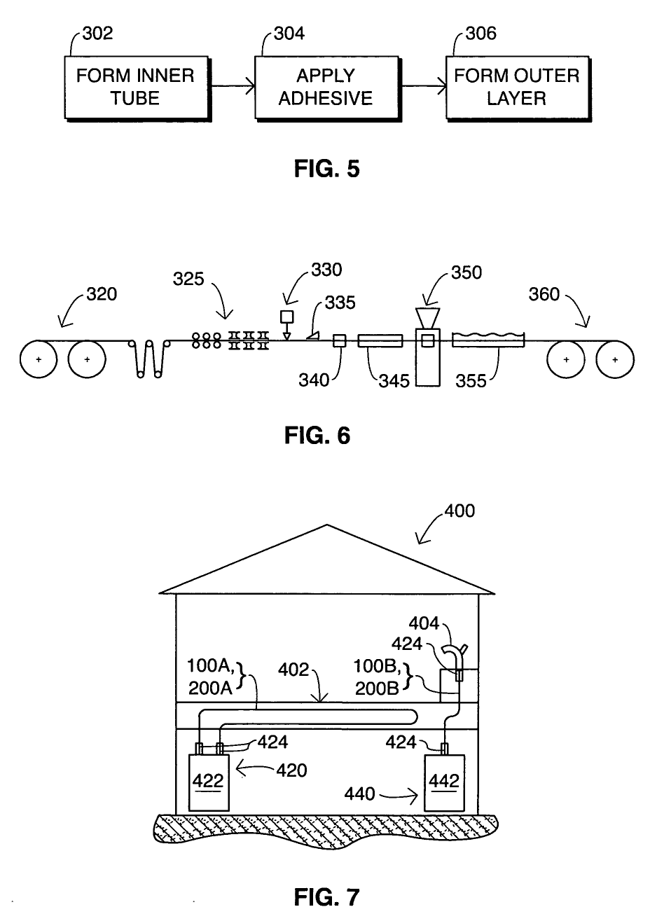

The inner tube 110 or 210 is formed (FIG. 5; Block 302). In the case of the tube 110, a flat, relatively narrow, elongate strip or tape of copper is provided from a reel 320 or the like. The metal strip is bent about its longitudinal axis by a bending or roll-forming apparatus 325 to form a cylindrical, tubular preform. The metal strip is bent such that the lateral edges thereof meet with one another or define a longitudinal gap of a prescribed width. The strip may be bent by a series of forming rolls.

The bent preform passes to a welding station 330 where the lateral edges of the strip are pressed together by further rolls and welded to form the continuous, longitudinally welded seam 118 (as shown, a butt welded seam). The edges can be welded by any suitable technique, including high frequency (HF) welding tungsten inert gas (TIG) welding, plasma welding or laser welding. According to some embodiments, the seam 118 is preferably HF welded. If necessary, any weld bead formed by the welding step may be removed by a scraper 335 or the like. The tube is then advanced through a shaping die 340.

The inner tube 210 is formed in the same manner as described above for the inner tube 110, except that the preform is formed from a flat, relatively thin, narrow, elongate, bimetallic strip or tape including a layer of copper prebonded to a layer of aluminum. The remainder of the steps are the same for both the tube assembly 100 and the tube assembly 200.

The inner tube 110, 210 is thereafter passed through a degreasing unit 345 that cleans the outer surface of the metallic layer to improve the bond between the outer surface and the adhesive layer.

The inner tube 110, 210 is thereafter passed to an adhesive applying apparatus 350 where the adhesive layer 130, 230 is applied to the outer surface of the inner tube 110, 210 (Block 304). According to some embodiments, the adhesive is circumferentially extruded onto the inner tube 110, 210. Alternatively, the adhesive may be applied by other techniques such as spraying or immersion. The outer layer 140, 240 is formed about the adhesive layer 130, 230 (Block 306). According to some embodiments, the outer layer 140, 240 is circumferentially extruded onto the adhesive layer 130, 230. According to some embodiments, the adhesive layer 130, 230 and the outer layer 140, 240 are co-extruded (e.g., using the apparatus 350). The adhesive and outer layers can be co-extruded using a dual crosshead. The outer layer may be applied (e.g., extruded) separately from the adhesive layer. The heat of the extruded material for forming the outer layer 140, 240 may serve to activate the adhesive layer 130, 230 to thereby form a bond between the adhesive layer 130, 230 and the outer surface of the inner tube 110, 210 and/or the inner surface of the outer layer 140, 240.

The tube assembly 100, 200 thus formed may thereafter pass through a cooling unit 355 (e.g., a cooling trough) and be wound onto a reel by a coiling apparatus 360.

Those skilled in this art will recognize that the steps set forth above can be carried out at separate stations, as part of a single continuous manufacturing line, or some combination of each. The tube assemblies 100, 200 may also be produced by other techniques known to and/or recognized by those skilled in this art as being suitable for manufacturing composite tubes.

As discussed above, the multilayer tube assemblies of the present invention may be used as heating tubes, sanitary tubes or gas tubes. Referring to FIG. 7, exemplary usages of the tube assemblies 100, 200 are shown therein. A building structure 400 such as a residence or commercial structure has a floor 402. A radiant heating system 420 is operable to provide heat to the structure. More particularly, the system 420 includes a heating apparatus (e.g., a boiler) 422 and a network or length of multilayer tube assembly 100A or 200A constructed as described above for the multilayer tube assemblies 100 or 200. The tube assembly 100A, 200A is operatively connected to the heating apparatus 422 by suitable fittings 424 (e.g., press fittings) to provide a circulation loop. A supply of fluid is heated by the heating apparatus 422 and circulated (e.g., by a pump or other forced flow apparatus forming a part of the heating apparatus 422 or otherwise) through the loop of tubing 100A, 200A so that the heat from the heating apparatus 422 is transferred to the floor 402. The tube assembly 100A, 200A may be located in or under the floor 402, a wall of the structure 400, or other suitable location. The circulated heat transfer fluid may be water, for example.

Referring again to FIG. 7, the structure 402 is also provided with a sanitary water supply system 440. The system 440 includes a water supply apparatus 442 such as a hot water heater including a supply of a fluid. According to some embodiments, the fluid is water. According to more particular embodiments, the fluid is potable water. According to some embodiments, the water is a hot water supply and has a temperature of between about 40 and 95° C. The water supply apparatus 442 is fluidly connected to a dispenser 404 by a length of multilayer tube assembly 100B or 200B corresponding to the multilayer tube assembly 100 or 200. The tube assembly 100B, 200B is connected to the water supply apparatus 442 and the dispenser 404 by fittings 424.

The multilayer tube assemblies 100, 200 according to the present invention may be used for the transport of any suitable fluid including liquids, gases, and mixtures thereof.

The multilayer tube assemblies 100, 200 may also include further outer layers, such as smooth or corrugated conduit, that surround the outer layers 140, 240.

According to some embodiments, the tube assemblies of the present invention (e.g., the tube assembly 100 or 200) satisfy or comply with the performance requirements of American Society for Testing and Materials (ASTM) Standard Specification F1281.00 and/or ASTM Standard Specification F1282.00.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A multilayer tube assembly for use with a fluid, the assembly comprising:
a) an inner tube having inner and outer opposed surfaces, the inner surface of the inner tube defining an open, longitudinally extending tube passage to allow flow of the fluid therethrough, wherein the inner tube is formed of metal;
b) an outer layer having an inner surface and surrounding at least a portion of the inner tube, wherein the outer layer is formed of a polymeric material; and
c) an adhesive layer interposed between the outer surface of the inner tube and the inner surface of the outer layer, wherein the adhesive layer secures the outer layer to the inner tube.

2. The assembly of claim 1 wherein at least the inner surface of the inner tube is formed of copper.

3. The assembly of claim 2 wherein the outer layer is formed of polyethylene.

4. The assembly of claim 3 wherein the outer layer is formed of at least one of HDPE, PE-RT, PEX, and LSZH compound.

5. The assembly of claim 1 wherein the outer layer is formed of polyethylene.

6. The assembly of claim 5 wherein the outer layer comprises at least one of HDPE, PE-RT, PEX, and LSZH compound.

7. The assembly of claim 1 wherein the adhesive layer is formed of an adhesive selected from the group consisting of ethylene acrylic acid, ethylene methylacrylate, and mixtures and formulations thereof.

8. The assembly of claim 1 wherein the inner tube includes a longitudinally extending welded seam.

9. The assembly of claim 8 wherein the welded seam is butt welded.

10. The assembly of claim 1 wherein the tube passage has a nominal inner diameter of between about 0.2 and 2.755 inches.

11. The assembly of claim 1 wherein the inner tube has a nominal wall thickness of between about 0.008 and 0.0236 inch.

12. The assembly of claim 1 wherein the outer layer has a nominal wall thickness of between about 0.031 and 0.078 inch.

13. The assembly of claim 1 wherein the adhesive layer has a thickness of between about 0.002 and 0.006 inch.

14. The assembly of claim 1 wherein the inner tube includes a first metallic layer including the inner surface of the inner tube and a second metallic layer surrounding the first layer and including the outer surface of the inner tube.

15. The assembly of claim 14 wherein the first and second layers are formed of different metals.

16. The assembly of claim 15 wherein the first layer is formed of copper and the second layer is formed of aluminum.

17. The assembly of claim 14 wherein the first layer has a nominal wall thickness of between about 0.002 and 0.006 inch and the second layer has a nominal wall thickness of between about 0.006 and 0.039 inch.

18. The assembly of claim 14 wherein:
a) the first layer is bonded to the second layer;
b) the adhesive layer is interposed between the second layer and the inner surface of the outer layer; and
c) the adhesive layer secures the outer layer to the second layer.

19. The assembly of claim 1 including a connector fitting secured to an end of the assembly and adapted to engage a second connector.

20. The assembly of claim 1 wherein the assembly complies with ASTM F1281.00 and/or ASTM F1282.00.

21. A system comprising:
a) a supply of a fluid;
b) a tube network including at least one multilayer tube assembly, each multilayer tube assembly comprising:
1) an inner tube having inner and outer opposed surfaces, the inner surface of the inner tube defining an open, longitudinally extending tube passage to allow flow of the fluid therethrough, wherein the inner tube is formed of metal;
2) an outer layer having an inner surface and surrounding at least a portion of the inner tube, wherein the outer layer is formed of a polymeric material; and
3) an adhesive layer interposed between the outer surface of the inner tube and the inner surface of the outer layer, wherein the adhesive layer secures the outer layer to the inner tube; and
c) a fluid transport apparatus operable to force the fluid to flow through the tube passage or passages of the at least one multilayer tube assembly.

22. The system of claim 21 wherein at least the inner surface of the inner tube is formed of copper.

23. The system of claim 21 wherein the outer layer is formed of polyethylene.

24. The system of claim 23 wherein the outer layer comprises of at least one of HDPE, PE-RT, PEX, and LSZH compound.

25. The system of claim 21 wherein the adhesive layer is formed of an adhesive selected from the group consisting of ethylene acrylic acid, ethylene methylacrylate, and mixtures and formulations thereof.

26. The system of claim 21 wherein the inner tube includes a longitudinally extending welded seam.

27. The system of claim 21 wherein:
a) the inner tube includes a first metallic layer including the inner surface of the inner tube and a second metallic layer surrounding the first layer and including the outer surface of the inner tube;
b) the first layer is bonded to the second layer;
c) the adhesive layer is interposed between the second layer and the inner surface of the outer layer;
d) the adhesive layer secures the outer layer to the second layer;
e) the first layer is formed of copper; and
f) the second layer is formed of aluminum.

28. The system of claim 21 wherein the fluid is a liquid.

29. The system of claim 28 wherein the fluid is potable water.

30. The system of claim 28 wherein the system includes a heater operable to heat the fluid.

31. A method for forming a multilayer tube assembly, the method comprising:
a) forming an inner tube having inner and outer opposed surfaces, the inner surface of the inner tube defining an open, longitudinally extending tube passage to allow flow of the fluid therethrough, wherein the inner tube is formed of metal;
b) applying an adhesive layer to the outer surface of the inner tube;
c) forming an outer layer having an inner surface and surrounding at least a portion of the inner tube such that the adhesive layer is interposed between the outer surface of the inner tube and the inner surface of the outer layer, wherein the inner tube is formed of a polymeric material; and
d) adhering the outer layer to the inner tube using the adhesive layer.

32. The method of claim 31 wherein at least the inner surface of the inner tube is formed of copper.

33. The method of claim 31 wherein the outer layer is formed of polyethylene.

34. The method of claim 33 wherein the outer layer comprises at least one of HDPE, PE-RT, PEX, and LSZH compound.

35. The method of claim 31 wherein the adhesive layer is formed of an adhesive selected from the group consisting of ethylene acrylic acid, ethylene methylacrylate, and mixtures and formulations thereof.

36. The method of claim 31 wherein forming the inner tube includes:
a) bending a metal strip into a generally cylindrical tube pre-form; and
b) welding the pre-form to form a longitudinally welded seam therein.

37. The method of claim 36 including forming the welded seam as a butt weld.

38. The method of claim 36 including HF welding the pre-form to form the welded seam.

39. The method of claim 36 including TIG welding, plasma welding, and/or laser welding the pre-form to form the welded seam.

40. The method of claim 31 including co-extruding the adhesive layer and the outer layer onto the outer surface of the inner tube.

41. The method of claim 31 wherein the inner tube includes a first metallic layer including the inner surface of the inner tube and a second metallic layer surrounding the first layer and including the outer surface of the inner tube.

42. The method of claim 41 wherein forming the inner tube includes:
a) providing a bimetallic strip including the first and second layers pre-bonded to one another; and
b) bending the bimetallic strip to form the inner tube.

43. A method for providing plumbing in an architectural structure for a flow of a fluid, the method comprising:
a) installing a tube network in the structure, the tube network including at least one multilayer tube assembly, each multilayer tube assembly comprising:
1) an inner tube having inner and outer opposed surfaces, the inner surface of the inner tube defining an open, longitudinally extending tube passage to allow flow of the fluid therethrough, wherein the inner tube is formed of metal;
2) an outer layer having an inner surface and surrounding at least a portion of the inner tube, wherein the outer layer is formed of a polymeric material; and
3) an adhesive layer interposed between the outer surface of the inner tube and the inner surface of the outer layer, wherein the adhesive layer secures the outer layer to the inner tube.

44. The method of claim 43 wherein at least the inner surface of the inner tube is formed of copper.

45. The method of claim 43 wherein the outer layer is formed of polyethylene.

46. The method of claim 45 wherein the outer layer comprises at least one of HDPE, PE-RT, PEX, and LSZH compound.

47. The method of claim 43 wherein the adhesive layer is formed of an adhesive selected from the group consisting of ethylene acrylic acid, ethylene methylacrylate, and mixtures and formulations thereof.

48. The method of claim 43 wherein the inner tube includes a longitudinally extending welded seam.

49. The method of claim 43 wherein:
a) the inner tube includes a first metallic layer including the inner surface of the inner tube and a second metallic layer surrounding the first layer and including the outer surface of the inner tube;
b) the first layer is bonded to the second layer;
c) the adhesive layer is interposed between the second layer and the inner surface of the outer layer; and
d) the adhesive layer secures the outer layer to the second layer;
e) the first layer is formed of copper; and
f) the second layer is formed of aluminum.

50. The method of claim 43 wherein installing the tube network includes mounting the tube network below a floor of the structure and operatively connecting the tube network to a fluid heater to provide a floor heating system.

51. The method of claim 43 wherein installing the tube network includes operatively connecting the tube network to a supply of potable water.
